(19) United States
(12) Patent Application Publication
(10) Pub. No.: US 2015/0371238 A1
(43) Pub. Date: Dec. 24, 2015

(54) PERSONAL HOLIDAY IMPUTATION FROM PAYMENT CARD TRANSACTIONAL DATA

(71) Applicant: MasterCard International Incorporated, Purchase, NY (US)

(72) Inventors: Qian Wang, Purchase, NY (US); Tong Zhang, Purchase, NY (US); Shen Xi Meng, Purchase, NY (US); Po Hu, Purchase, NY (US)

(21) Appl. No.: 14/311,528

(22) Filed: Jun. 23, 2014

(51) Int. Cl. G06Q 30/02; G06Q 40/00

(52) U.S. Cl. CPC G06Q 30/02; G06Q 40/12

(57) ABSTRACT

A computer-implemented method of imputing a personal holiday associated with a consumer into a forecast model includes steps, using a processing device, for accessing transaction records associated with purchasing activity of a consumer in a payment network over a predetermined period of time, the transaction records including information about a purchase and date when the purchase was made. The method further includes predicting a personal holiday of the consumer within the predetermined period of time based on the transaction records, wherein the personal holiday repeats at regular intervals within the predetermined period of time; and imputing the date into a forecast model to predict future purchase activity of the consumer. A system includes a processing device and memory to store instructions that, when executed by the processing device, cause the processing device to perform the operations comprising the method steps of the computer-implemented method.

### BACKGROUND

1. Field of the Disclosure

The present disclosure relates to data mining of transaction data associated with a payment network, and, more particularly, to a method for imputing a personal holiday date associated with a consumer into an individualized forecasting model, based on payment card transaction data.

2. Brief Discussion of Related Art

Payment card networks receive transaction data from millions of merchants worldwide on a daily basis. Transaction records associated with payment card usage is typically stored for up to five years. While such records have been mined for different marketing purposes to add value to the many merchants the payment card network serves, typically, the usage of transaction records has been directed to the behavior of a consumer group, for example, by geographic location, or common interests. To date, such analyses have not been targeted to individual behaviors in order to obtain valuable targeted marketing information, in part, due to the need to protect privacy rights of the consumer.

### SUMMARY

Features of the disclosure will become apparent from the following detailed description considered in conjunction with the accompanying drawings. It is to be understood, however, that the drawings are designed as an illustration only and not as a definition of the limits of this disclosure.

The present disclosure is directed to a method and system for detecting and extracting personal holiday dates and related purchasing preferences associated with a consumer from historical transaction data generated in a payment network. Such information can then be accessed by merchants for providing timely and appropriate purchase opportunities to consumers on a highly individualized basis.

In one aspect, the present disclosure is directed to a method for imputing a personal holiday associated with a consumer into a forecast model, the method includes accessing, using a processing device, transaction records associated with purchasing activity of a consumer over a predetermined period of time, the transaction records being associated with a payment network and including information about a purchase and a calendar date when the purchase was made. The method also includes predicting, using the processing device, a date associated with a personal holiday of the consumer within the predetermined period of time based on the transaction records, wherein the personal holiday repeats at regular intervals within the predetermined period of time; and imputing, using the processing device, the date into a forecast model to predict future purchase activity of the consumer associated with the personal holiday.

In another aspect, the method further includes identifying, using the processing device, a pattern of purchases by the consumer associated with the personal holiday based on the information derived from the transaction records, the information from each of the transaction records including the calendar date of purchase and at least one of a type of good, a quantity of the type of good, a merchant location, and a type of merchant.

In still another aspect, the type of good associated with at least one of the transaction records is determined from a stock keeping unit listed in the transaction record.

In a further aspect, the type of merchant associated with at least one of the transaction records is determined from a merchant category code listed in the transaction record.

In another aspect, the pattern of purchases is identified by applying time-series analysis based on the information derived from the transaction records over the predetermined period of time to identify repeated purchasing activity of the consumer within the predetermined period of time.

In yet another aspect, the personal holiday is an annual personal holiday and the predetermined period of time is at least five years.

In still yet another aspect, the method further includes evaluating, using the processing device, the date of the personal holiday from the predicting step by measuring a statistical criterion, and adjusting the date and the future purchasing activity associated with the personal holiday in response to the measured statistical criterion failing to meet a predetermined threshold.

In another aspect, the method further includes imputing into the forecast model one or more purchasing preferences of the consumer associated with the personal holiday based on the transaction records, the one or more purchasing preferences including a type of good, a location of a merchant, a type of merchant, a merchant, a good, and a cost of the good.

The personal holiday may be a birthday, the pattern of purchases being based on transaction records comprising at least one type of good associated with birthdays periodically repeating on an annual basis.

The present disclosure is also directed to a system to impute a personal holiday associated with a consumer into a forecast model. The system includes a processing device; and memory to store instructions that, when executed by the processing device, cause the processing device to perform operations including accessing transaction records associated with purchasing activity of a consumer over a predetermined period of time, the transaction records being associated with a payment network and including information about a purchase and a calendar date when the purchase was made. The operations further include predicting a date associated with a personal holiday of the consumer within the predetermined period of time based on the transaction records, wherein the personal holiday repeats at regular intervals within the predetermined period of time; and imputing the date into a forecast model to predict future purchase activity of the consumer associated with the personal holiday.

In one aspect of the system, the operations further include identifying a pattern of purchases by the consumer associated with the personal holiday based on information derived from the transaction records, the information from each of the transaction records including the calendar date of purchase and at least one of a type of good, a quantity of the type of good, a merchant location, and a type of merchant.

In another aspect, the type of good associated with at least one of the transaction records is determined from a stock keeping unit listed in the transaction record.

The type of merchant associated with at least one of the transaction records, in one aspect, is determined from a merchant category code listed in the transaction record.

In various additional aspects, the pattern of purchases is identified by applying time-series analysis based on the information derived from the transaction records over the predetermined period of time to identify repeated purchasing activity of the consumer within the predetermined period of time.

In still another aspect, the operations further include evaluating the date of the personal holiday from the predicting step by measuring a statistical criterion, and adjusting the date and the predicted time frame in response to the measured statistical criterion failing to meet a predetermined threshold.

In still further aspects, the operations include imputing into the forecast model one or more purchasing preferences of the consumer associated with the personal holiday, based on the transaction records, the one or more purchasing preferences including a type of good, a location of a merchant, a type of merchant, a merchant, a good, and a cost of the good.

The present disclosure is also directed to a non-transitory computer-readable medium storing instructions that, when executed by a processing device, cause the processing device to impute a personal holiday associated with a consumer into a forecast model, by performing a computer process including the operations of accessing transaction records associated with purchasing activity of a consumer within a payment network over a predetermined period of time, the transaction records being associated with a payment network and including information about a purchase and a calendar date when the purchase was made; predicting a date associated with a personal holiday of the consumer within the predetermined period of time based on the transaction records, wherein the personal holiday repeats at regular intervals within the predetermined period of time; and imputing the date into a forecast model to predict future purchasing activity of the consumer associated with the personal holiday.

In one aspect, the non-transitory computer-readable medium includes operations further including identifying a pattern of purchases by the consumer associated with the personal holiday based on information derived from the transaction records, the information from each of the transaction records including the calendar date of purchase and at least one of a type of good, a quantity of the type of good, a merchant location, and a type of merchant.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic illustration of a representative cycle of transaction processing by a payment network of an electronic cashless sale.

FIG. 2 is a flow diagram representation of an embodiment of a method of the present disclosure.

FIG. 3 is a schematic representation of an embodiment of a system for implementing various embodiments of the methods of the present disclosure.

### DETAILED DESCRIPTION OF THE EMBODIMENTS

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

It should also be understood that the order of steps or order for performing certain actions is immaterial, as long as the method remains operable. Moreover, two or more steps or actions may be conducted simultaneously.

The term “transaction data” is used herein to refer to data associated with any recorded cashless transaction, including any transaction using a payment card, for example, a credit card, debit card, PIN debit card, ATM card, electronic funds transfer (EFT), near field communications (NFC) payments, smartphone wallet transactions, and so on, as well as those electronic payments using ACH and electronic wire.

The term “payment network” generally refers to a payment network for handling cashless transactions and is often associated with a single payment card issuer, such as a credit card issuer. However, the term “payment network” as used herein can encompass both single card issuer networks and a network, such as a network of wallets that includes multiple card issuers.

The term “timestamp” refers to a calendar date and, usually, also a time of day, provided in a transaction record to indicate when the transaction was completed or when the transaction record was generated.

The various methods of the present disclosure are preferably implemented as executable programs stored on a server device and executed by a processing device associated with the server device. Such server devices may be maintained and operated by a payment network operator, or by a third-party hosting operator. The flow of various embodiments of the method of the present disclosure for imputing a personal holiday date associated with a consumer from payment card transaction data into an individualized forecasting model is preferably directed by the hosted executable program code running on the server device or on any appropriate device known in the art for providing the embodiments of the methods of the present disclosure.

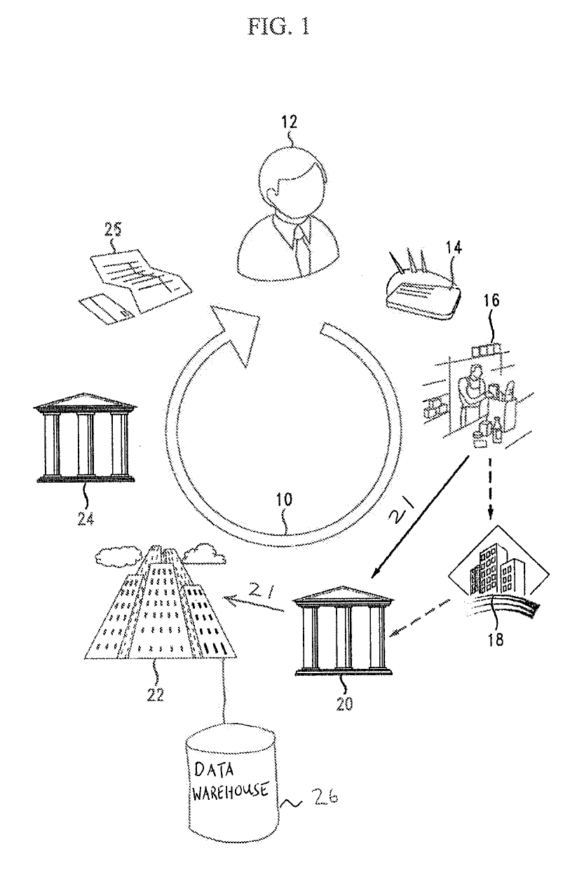

Referring to FIG. 1, in one embodiment of a typical cashless transaction a device holder 12 presents a payment instrument 14 to a merchant 16 for payment. Though the payment instrument is shown as a payment card, it can also be a transponder device, NFC-enabled smart phone, or any digital wallet selected for remote or on-line payment or provided as a mobile device app. In cases where the merchant 16 has an established merchant account with an acquiring bank (also called the acquirer) 20, the merchant communicates with the acquirer to secure payment on the transaction by sending a transaction request 21. An acquirer 20 is a party or entity, typically a bank, which is authorized by the network operator 22 to acquire network transactions on behalf of customers of the acquirer 20 (e.g., merchant 16). The merchant 16 may alternatively secure payment on a transaction through a third-party payment provider 18 authorized by the acquirer 20 and the network operator 22 to acquire payments on network transactions on behalf of the merchants. In this way, the merchant 16 can be authorized and able to accept the payment device 14 from a device holder 12, without having a merchant account with the acquirer 20.

The acquirer 20 typically populates and routes the transaction request 21 from the merchant to a network operating system (also referred to as “network operator”) 22 controlled by the network operations entity (for example, assignee MasterCard International Incorporated). The data included in the transaction request identifies the source of funds, or type of payment, used for the transaction. With this information, the network operator 22 routes the transaction to an issuer 24, typically a bank, which is authorized by the network operator 22 to issue payment devices 14 on behalf of its customers (e.g., device holder 12), for use in payment transactions within the payment network. The issuer 24 also typically funds the transaction that it approves. The issuer 24 may approve or authorize the transaction request based on criteria such as a device holder's credit limit, account balance, or in certain instances more detailed and particularized criteria including transaction amount, merchant classification and so on.

The issuer 24 decision to authorize or decline the transaction is routed through the network operator 22 and acquirer 20, and ultimately to the merchant 16 at the point of sale. This entire process is carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless electronic payment, while the merchant 16 can be assured that payment is secured.

The issuer 24 may also periodically generate a statement of the cashless transactions 25 for the benefit of the device holder 12 that lists all of the device holder's 12 purchases with the payment instrument 14 over a specified period of time.

The transaction request from the merchant, which includes details of the payment transaction for authorization, is generally further populated by the acquirer 20 with merchant information and then forwarded to the issuer. A central database, or data warehouse 26, is also associated with and maintained by the payment network for storing and augmenting this payment transaction data on a regular basis for use in marketing, macroeconomic reporting, and so on.

Each payment card transaction record that is stored in the data warehouse 26 is associated with a consumer, and includes at least a date and time of the transaction, an account number, cardholder ID, and/or other identifying data of the cardholder making the purchase, a merchant ID and/or merchant name, and, generally, other merchant location and/or identification information of the merchant associated with the transaction, along with additional details of the purchase. Such additional purchase information recorded in the transaction records typically includes the number, type, and cost of each good purchased. Accordingly, for any particular cardholder/consumer, a time-stamped listing of the consumer's purchasing activity can be obtained, including information on a type of good, number of each type of good purchased, and the cost of each good.

Details of the information about a purchase are identifiable in a number of ways known in the art. For example, as one of ordinary skill in the art will appreciate, the type of good purchased can be indicated by a textual description of the good listed in the transaction record, similar to what may be provided on a sales receipt. Optionally or additionally, the transaction record may list a Stock Keeping Unit, or “SKU,” which can be used to determine the type of good purchased. Many merchants use the well-known Universal Product Code (UPC) designations as their SKU's. Others record the UPC in addition to a SKU that is specific to their own inventory system. Still other merchants may track only a SKU that is not universal. In various embodiments of the disclosure, therefore, in order to identify a particular type of good from a transaction record, a database of UPC's as well as certain merchants' SKU's is preferably maintained for comparison to a SKU and/or UPC listed in a transaction record.

In various embodiments, where a particular SKUs and/or PCUs are known to be associated with a particular type of good, a consumer's pattern of purchasing a particular type of good can be analyzed based on the corresponding SKU and/or PCU numbers recorded in the historical transaction records.

Similarly, a type of merchant is commonly determined from a merchant category code (MCC) which is usually listed in each transaction record.

It is customary for payment networks to save such transaction records for its customers for up to five-years. Such data has been mined and analyzed in the past to categorize spending habits of groups of customers over different shopping seasons including shopping seasons based on public holidays, such as Christmas. However, to date, no method or system is known that can determine a personal holiday, for example, a birthday or anniversary, from transaction records associated with a payment network, or impute a consumer's personal holiday date into an individualized forecasting model to generate personalized advertising to a consumer.

The present disclosure includes a system and methods for identifying dates of personal holidays from the transaction data associated with a consumer, and analyzing the consumer's individual consumption habits based on those personal holidays. The system and methods of the present disclosure are also directed to identifying preferred goods that the consumer may purchase related to the personal holiday. The preferred goods and information associated therewith can be identified from transaction data and used by merchants to provide highly individualized timely and appropriate commodities to each of its consumers. Such information can include specific preferred products, preferred brands, or other preferences, such as preferred style of a design of a product.

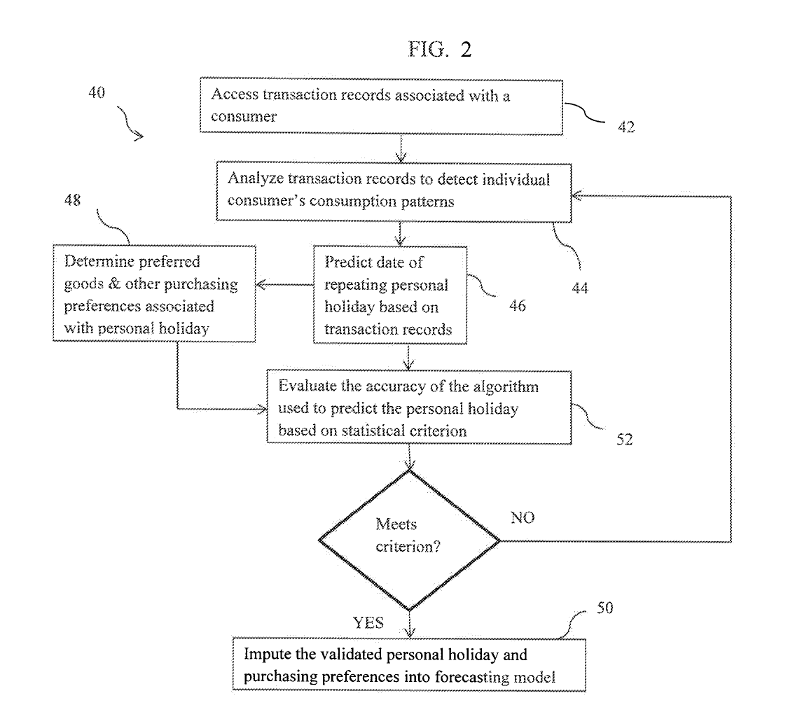

Referring to FIG. 2, one embodiment of a method 40 of the present disclosure includes accessing transactions records associated with purchasing activity of a consumer over a predetermined time 42. For example, the transaction records associated with a payment network saved over a period of five years can be accessed and grouped according to consumer ID, account number or other identifying information, in order to analyze each consumer's transaction history, and to identify each consumer's personal holiday based on the transaction records specific to that consumer.

In other embodiments, the predetermined time can be any one of two, three, or four years.

In other embodiments, the predetermined time can be a year, particularly if the personal holiday that is to be determined is known to occur repeatedly within the year, for example, on a monthly or quarterly basis.

The transaction records associated with a particular consumer can be identified by a cardholder ID, account number, name, or other identifying information recorded in the transaction records. The transaction records associated with a single consumer, covering a sufficient period of time, provide information that can be used to gauge that consumer's historical, and future, periodic spending habits.

In various embodiments, the consumer's historical transaction data is analyzed using, for example, longitudinal data analysis methodologies known in the art, to detect consumption patterns particular to the consumer 44 and to identify a repeating personal holiday (on a monthly, semi-annual, annual basis) and a repeating time frame around or leading up to the personal holiday during which, for example, the customer purchased particular types of goods or purchased a larger amount of the particular type of good. The patterns identified may show some similarity to public holidays; however, the consumption patterns of the purchases in accordance with the present disclosure vary because of the difference in personal life styles, cultural background, social networking, and so on.

Referring still to FIG. 2, the method further includes predicting a date of a personal holiday based on the information about the purchase accessed from the transaction records 46, including the dates of the purchases. Such information includes a location of the merchant from which purchase was made, a type of good purchased, an amount of the types of particular goods purchased, a cost of the goods, a type of merchant from which the goods were purchased. For example, using known longitudinal data and time analysis, a pattern of purchasing a particular type and amount of a good that is associated with a personal holiday, for example, a birthday (candles, greeting cards, for example), would likely show spikes on a repeating or periodic basis during a short time frame leading up to, and possibly including a short time after, the actual birthday.

Once the personal holiday date is predicted or determined, the consumer's other purchases around the time of the personal holiday are preferably analyzed to determine future purchasing preferences of the consumer associated with the personal holiday 48 on an individualized basis, using various methods known in the art such as an Apriori algorithm, as described, for example, in Rakesh Agrawal and Ramakrishnan Srikant, “Fast algorithms for mining association rules in large databases,” Proceedings of the 20th International Conference on Very Large Data Bases, VLDB, pages 487-499 (Santiago, Chile, September 1994). These purchasing preferences can also be used to help evaluate the accuracy of the algorithm developed at block 52, as described further below. Since people celebrate in different ways, the determination of purchasing preferences can be used by merchants and others for individualized or customized marketing and can also help identify superior, or preferred, goods associated with the personal holiday on an individualized basis.

Purchasing preferences can include any one or more of a type or a class of good, including by SKU number, a location of a merchant, a type of merchant (which may be identified from a merchant category code listed in the transaction records, for example), a preferred merchant identified by name or other identifying information, a cost of the good, and so on.

Referring still to FIG. 2, the method preferably also includes imputing the predicted date and, preferably, the purchasing preferences associated with the date of the personal holiday, into a forecast model 50 to predict future time frames during which the consumer will likely be making purchases, along with the customer's purchasing preferences associated with the personal holiday. Such information can then be used to create timely and personalized advertising opportunities or personalized sales opportunities for the consumer.

Still referring to FIG. 2, in various additional embodiments, once the date of the personal holiday is predicted at 46 and the preferred goods and other purchasing preferences associated with the predicted holiday identified at 48, the methodology (the types of merchants the consumer purchased goods from, types of goods, location of merchants, and so on used to predict the personal holiday) and accuracy of the algorithm in predicting the personal holiday and purchasing preferences is then preferably evaluated 52.

For example, the algorithm, or pattern codes, for predicting the personal holiday can be evaluated by applying the algorithm to another consumer for whom the actual personal holiday is known through some other source, and who is in a similar demographic group. Alternatively, the algorithm could be applied to the consumer for which the predicted personal holiday is made using known public holidays to increase the confidence of the time series analysis in predicting the date of the personal holiday and in predicting future purchasing preferences.

For example, in determining whether a particular historical purchase date indicates a personal holiday, two situations may arise. In one case, the customer may opt-in to give his/her personal holiday, so that it is easy to identify purchasing preferences associated with the personal holiday. In the other case, there is no information provided as to the date of a personal holiday so that it is necessary to make a prediction of whether a historical purchase day is a special personal holiday. In this latter case, various statistical classification methods can be used, such as logistic regression or linear discriminative analysis to make the prediction.

For example, the algorithms, or pattern codes, are utilized to create a probability score to predict the likelihood of purchasing certain goods in a given period. The score may be set from 0 (very unlikely) to 1 (100% likely) to describe the purchase probability in the near future.

Because the methods of the present disclosure rely on the facts of periodical repeat events, it may not be necessary to develop a statistical model. However, patterns that are developed from statistical models of the transactional data to predict a personal holiday can be evaluated by measuring certain statistical criterion. For example, in one embodiment, Kolmogorov-Smirnov (“KS”) statistics can be used to measure the performance of a model to predict a specific event, or personal holiday (versus an apparent historical purchase which is a “non-event,” i.e., not associated with a personal holiday).

If the output of the evaluation does not meet a predetermined threshold of one or more statistical criterion, a message is preferably returned to an analysis module for further anafdanalysis of the transaction records to detect consumption patterns 44 with some improvement suggestions. Otherwise, if the statistical criteria are met, the pattern codes are delivered to a forecasting module to impute the predicted personal holiday, and preferably the purchasing preferences, into a forecasting model 50. Other target(s) with other variables (from internal or external sources) can also be used to develop the forecasting model based on, for example, a measurement of the recency of a particular purchase, frequency, time series, and distance traveled from one's residence to the merchant location.

### Embodiment of a System for Implementing the Methods of the Present Disclosure

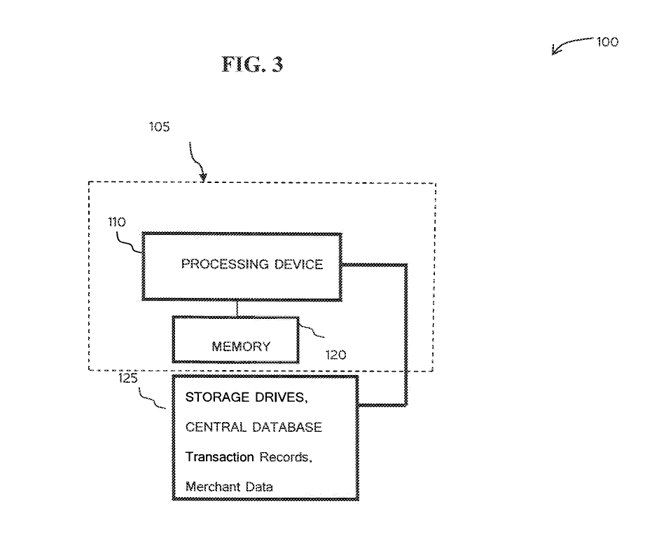

Referring to FIG. 3, the various embodiments of the methods of the present disclosure are implemented via computer software or executable instructions or code. FIG. 3 is a schematic representation of an embodiment of a system 100 for implementing the methods of the present disclosure. The system includes computing device 105 having at least a processor 110, for example, a Central Processing Unit (CPU), storage or memory 120, and also includes or, is operably connected to, a storage device 125 that stores transactions records associated with one or more payment networks. For example, the storage device can include a central database or data warehouse associated with the payment network that retrieves and stores the transaction records, as represented by data warehouse 26 in FIG. 1.

The memory 120 includes computer readable memory accessible by the CPU for storing instructions that when executed by the CPU 110 causes the processor 110 to implement the steps of the methods described herein. The memory 120 can include random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the system 100, or distributed among various types of memory devices provided, and the necessary portions loaded into RAM, for example, upon execution.

The present disclosure is also directed to a non-transitory computer readable product, such as a computer readable medium or device, to store computer executable instructions or program code that, when executed by a processing device, cause the processing device to perform operations comprising the method steps described herein.

It should be recognized that the components illustrated in FIG. 3 are exemplary only, and that it is contemplated that the methods described herein may be implemented by various combinations of hardware, software, firmware, circuitry, and/or processors and associated memory, for example, as well as other components known to those of ordinary skill in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of imputing a personal holiday associated with a consumer into a forecast model, the method comprising:
accessing, using a processing device, transaction records associated with purchasing activity of a consumer over a predetermined period of time, the transaction records being associated with a payment network and including information about a purchase and a calendar date when the purchase was made;
predicting, using the processing device, a date associated with a personal holiday of the consumer within the predetermined period of time based on the transaction records, wherein the personal holiday repeats at regular intervals within the predetermined period of time; and
imputing, using the processing device, the date into a forecast model to predict future purchase activity of the consumer associated with the personal holiday.

2. The method of claim 1, further comprising:
identifying, using the processing device, a pattern of purchases by the consumer associated with the personal holiday based on the information derived from the transaction records, the information from each of the transaction records including the calendar date of purchase and at least one of a type of good, a quantity of the type of good, a merchant location, and a type of merchant.

3. The method of claim 2, wherein the type of good associated with at least one of the transaction records is determined from a stock keeping unit listed in the transaction record.

4. The method of claim 2, wherein the type of merchant associated with at least one of the transaction records is determined from a merchant category code listed in the transaction record.

5. The method of claim 2, wherein the pattern of purchases is identified by applying time-series analysis based on the information derived from the transaction records over the predetermined period of time to identify repeated purchasing activity of the consumer within the predetermined period of time.

6. The method of claim 5, wherein the personal holiday is an annual personal holiday and the predetermined period of time is at least five years.

7. The method of claim 1, the method further comprising evaluating, using the processing device, the date of the personal holiday from the predicting step by measuring a statistical criterion, and adjusting the date and the future purchasing activity associated with the personal holiday in response to the measured statistical criterion failing to meet a predetermined threshold.

8. The method of claim 1, the method further comprising imputing into the forecast model one or more purchasing preferences of the consumer associated with the personal holiday based on the transaction records, the one or more purchasing preferences including a type of good, a location of a merchant, a type of merchant, a merchant, a good, and a cost of the good.

9. The method of claim 2, wherein the personal holiday is a birthday, the pattern of purchases being based on transaction records comprising at least one type of good associated with birthdays periodically repeating on an annual basis.

10. A system to impute a personal holiday associated with a consumer into a forecast model, the system comprising:
a processing device; and
memory to store instructions that, when executed by the processing device, cause the processing device to perform operations comprising:
accessing transaction records associated with purchasing activity of a consumer over a predetermined period of time, the transaction records being associated with a payment network and including information about a purchase and a calendar date when the purchase was made;
predicting a date associated with a personal holiday of the consumer within the predetermined period of time based on the transaction records, wherein the personal holiday repeats at regular intervals within the predetermined period of time; and
imputing the date into a forecast model to predict future purchase activity of the consumer associated with the personal holiday.

11. The system of claim 10, the operations further comprising:
identifying a pattern of purchases by the consumer associated with the personal holiday based on information derived from the transaction records, the information from each of the transaction records including the calendar date of purchase and at least one of a type of good, a quantity of the type of good, a merchant location, and a type of merchant.

12. The system of claim 11, wherein the type of good associated with at least one of the transaction records is determined from a stock keeping unit listed in the transaction record.

13. The system of claim 11, wherein the type of merchant associated with at least one of the transaction records is determined from a merchant category code listed in the transaction record.

14. The system of claim 11, wherein the pattern of purchases is identified by applying time-series analysis based on the information derived from the transaction records over the predetermined period of time to identify repeated purchasing activity of the consumer within the predetermined period of time.

15. The system of claim 14, wherein the personal holiday is an annual personal holiday and the predetermined period of time is at least five years.

16. The system of claim 10, the operations further comprising evaluating the date of the personal holiday from the predicting step by measuring a statistical criterion, and adjusting the date and the predicted time frame in response to the measured statistical criterion failing to meet a predetermined threshold.

17. The system of claim 10, the operations further comprising imputing into the forecast model one or more purchasing preferences of the consumer associated with the personal holiday, based on the transaction records, the one or more purchasing preferences including a type of good, a location of a merchant, a type of merchant, a merchant, a good, and a cost of the good.

18. The system of claim 11, wherein the personal holiday is a birthday, the pattern of purchases being based on transaction records comprising at least one type of good associated with birthdays periodically repeating on an annual basis.

19. A non-transitory computer-readable medium storing instructions that, when executed by a processing device, cause the processing device to impute a personal holiday associated with a consumer into a forecast model, by performing a computer process comprising the operations:
accessing transaction records associated with purchasing activity of a consumer within a payment network over a predetermined period of time, the transaction records being associated with a payment network and including information about a purchase and a calendar date when the purchase was made;
predicting a date associated with a personal holiday of the consumer within the predetermined period of time based on the transaction records, wherein the personal holiday repeats at regular intervals within the predetermined period of time; and
imputing the date into a forecast model to predict future purchasing activity of the consumer associated with the personal holiday.

20. The non-transitory computer-readable medium of claim 19, the operations further comprising:
identifying a pattern of purchases by the consumer associated with the personal holiday based on information derived from the transaction records, the information from each of the transaction records including the calendar date of purchase and at least one of a type of good, a quantity of the type of good, a merchant location, and a type of merchant.
